(19) United States
(12) Patent Application Publication
(10) Pub. No.: US 2003/0050053 A1
(43) Pub. Date: Mar. 13, 2003

(54) Communication apparatus

(75) Inventors: Wan Wang, Kanagawa-ken (JP); Akira Ishikura, Kanagawa-ken (JP)

Correspondence Address: BANNER & WITCOFF, 1001 G STREET N W, SUITE 1100, WASHINGTON, DC, 20001, US

(73) Assignee: Kabushiki Kaisha Toshiba, Minato-ku (JP)

(21) Appl. No.: 10/223,698

(22) Filed: Aug. 20, 2002

(30) Foreign Application Priority Data
Aug. 20, 2001 (JP) P2001-249512

(51) Int. Cl. H04Q 7/20

(52) U.S. Cl. 455/418; 455/466

(57) ABSTRACT

The retrieval unit 1101 retrieves service information including a type of a cellular phone, ESN and a software version from the memory 109. The retrieval unit 1101 converts the service information into formatted data to be transmitted by Short Message Service (SMS). Then the retrieval unit 1101 transmits the converted data to a communication party.

### RELATED APPLICATION INFORMATION

This application claims the benefits of priority under 35 U.S.C. § 119 to Japanese patent application No. P2001-249512, filed Aug. 20, 2001, the entire contents of which are incorporated herein by reference.

### FIELD OF THE INVENTION

This invention is related to a communication apparatus that reports service information, such as identification information that identifies the communication apparatus. The communication apparatus may report the service information to, for example, a service provider that provides communication service for the communication apparatus.

### DESCRIPTION OF THE RELATED ART

After an user purchased a communication apparatus, such as a a cellular phone, or wireless personal digital assistant, , the user contacts registers the communication device with a communication network maintained by a communication service provider. For example, if the user has purchased a wireless telephone, the user may register the telephone with a wireless service provider like AT&T Wireless, Verizon or Sprint.

If a problem with the communication apparatus arises, the user may seek assistance from the communication service provider. In this situation, the service provider will often need information about the type of communication device, the software used in the communication device, or identification information identifying the communication device. This information will generally be referred to hereafter as “service information.” For example, if the communication device is a wireless telephone, then the service provider may require the Electrical Serial Number (ESN). As known to those of ordinary skill in the art, the ESN uniquely identifies a wireless telephone to a communication network.

Referring now to various service information for a wireless telephone is typically printed on a label 703 located on the back of the cellular phone 701 under a battery 702. For example, a shown in FIG. 6, this service information may includes a model number for the wireless telephone “HCDM-2100” along with the ESN for the wireless telephone “1350568199”. Accordingly, if the service provider requests this particular service information, the user must first remove the battery 702 from the cellular phone 701. This process substantially delays the user in giving the required service information to the service provider. Further, if the user is communicating with the service provider with the wireless telephone, the user will end the communication and power down the wireless telephone by removing the battery 702 to read the service information.

In addition to service information printed at inconvenient locations on the communication apparatus, some service information may be even more inaccessible to the average user. For example, the service provider may require information regarding the software employed by the communication apparatus, such as the type or version of the software employed by the communication apparatus. The average user may not know how to retrieve this service information. Accordingly, there is a need for a system that easily and conveniently retrieves service information for use by, for example, a service provider.

### SUMMARY OF THE INVENTION

Advantageously, various aspects of the present invention provide a system for use by a communication apparatus that conveniently retrieves service information. The system then delivers the retrieved service information to a recipient, such as a service provider for the communication apparatus.

Advantageously, various aspects of the present invention provide a system for use by a communication apparatus that conveniently retrieves service information. The system then delivers the retrieved service information to a recipient, such as a service provider for the communication apparatus.

More particularly, various embodiments of the invention provide a communication apparatus having a memory configured to store service information relating the communication apparatus. The service information may include, for example, identification information that uniquely identifies the communication apparatus. The communication apparatus also includes a retrieval unit that retrieves service information from the memory, and provides the retrieved service information to a designated recipient. As will be discussed in detail below, the retrieval unit receives a command to retrieve service information from the memory. In response, the retrieval unit retrieves the specified service information, and provides the retrieved service information to a designated recipient. For example, the retrieval unit may transmit the retrieved service information to another party, such as the service provider for the communication apparatus.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 shows a functional block diagram of a communication apparatus according to the one embodiment of the invention.

FIG. 2 shows an flowchart depicting an exemplary procedure for providing service information to a service center according to the embodiment of the invention illustrated in FIG. 1.

FIG. 3 depicts exemplary images that may display service information according to an embodiment of the invention.

FIG. 4 shows a data format to provide service information according to the embodiment of the invention illustrated in FIG. 1.

FIG. 5 shows a functional block diagram of a communication apparatus according to another embodiment of the invention.

FIG. 6 shows an illustrative flowchart depicting an exemplary procedure for providing service information to a service center recipient according to the embodiment of the invention illustrated in FIG. 4.

FIG. 7 shows a conventional communication apparatus with the battery pack removed.

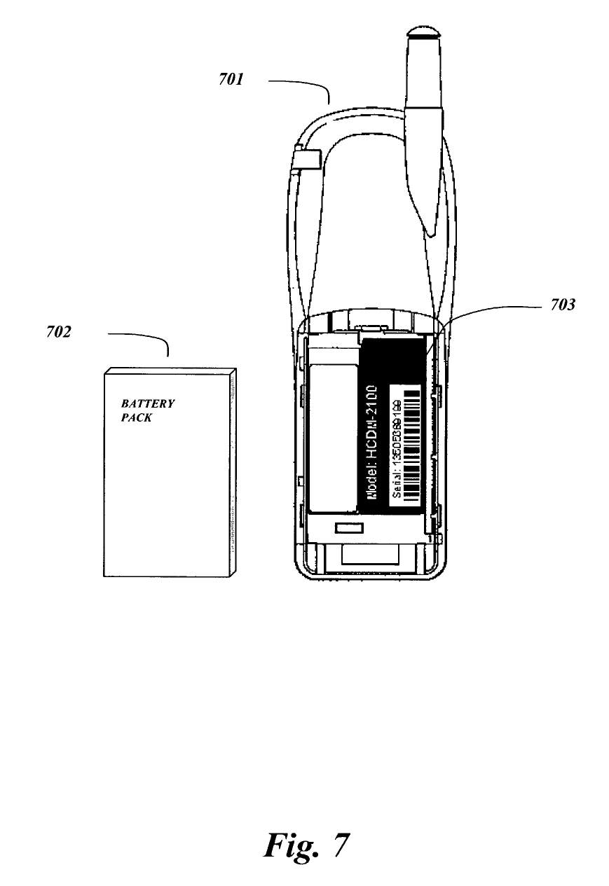

### DETAILED DESCRIPTION

First Exemplary Communication Apparatus

As noted above, the present invention relates to a system implemented that conveniently retrieves and provides service information for a communication apparatus. Accordingly, an exemplary communication apparatus by which various embodiments of the invention may be implemented will first be described.

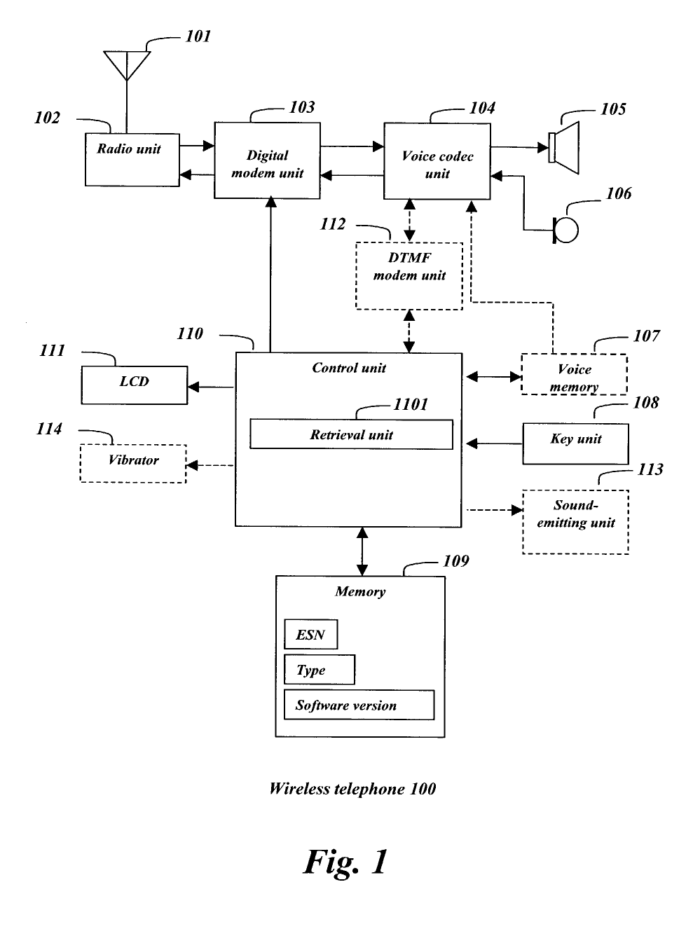

FIG. 1 is a block diagram showing the components of a communication apparatus according to one embodiment of the present invention. More particularly, this figure illustrates the components of a wireless telephone 100 implementing an embodiment of the invention. The wireless telephone 100 has an antenna 101, a radio unit 102, a digital modem unit 103, a voice codec unit 104, a speaker 105, a microphone 106, a voice memory 107, a key unit 108, a memory 109, a control unit 110, a display 111, a Dual Tone Multiple Frequency (DTMF) modem unit 112, a sound-emitting unit 113 and a vibrator 114. Each of these components will be described in turn.

The antenna 101 receives radio frequency signals transmitted from a base station of a communication a network over a radio channel. The received signal is then input to the radio unit 102. As is well known to those of ordinary skill in the art, the radio unit 102 converts the received signal into a lower frequency signal by mixing it with a synthesizing signal. The modem unit 103 then demodulates the converted frequency signal into voice data, which is input into the voice codec unit 104. The voice codec unit 104 decodes the input voice data, and in turn provides the decoded voice data into the speaker 105. The speaker 105 then outputs the decoded voice data to a user as sound.

The antenna 1 receives a radio frequency signal transmitted from a base station over a radio channel. The received signal is inputted to the radio unit 102.

When the user wishes to send a voice message to another party, the microphone 106 converts the sound of the user's voice into an analog electrical signal. The converted voice signal is then input into the voice codec unit 104, which encodes the input signal. The coded signal is inputted into the digital modem unit 103, which modulates the input signal as voice data for transmission. The modulated voice data is provided to the radio unit 102, which transmits the modulated voice data to a base station of a communication a network through the antenna 101.

As previously noted, the wireless telephone 100 includes a voice memory 107. The voice memory 107 stores, for example, one or more outgoing messages that are transmitted in response to incoming calls when the wireless phone is set in an automatic answering mode. The voice memory 107 also stores incoming messages that are received in response to the outgoing message. These stored voice data and voice message are output to the speaker 105 through the voice codec unit 104.

The key unit 108 may be, for example, a conventional touch keypad. As is well known in the art, a user may employ the key unit 108 to directly input data into the wireless telephone 100. The key unit 108 can be used to input a variety of data, such as a telephone number to be dialed, information to be stored, or other commands instructing the wireless telephone 100 to take some action.

The memory 109 may be implemented using a microcircuit device, such as a flash read only memory (FROM) device, an electrically erasable programmable read only memory (EEPROM) circuit, or the like. The memory 109 may include read-only memory (ROM), read/write memory (RAM), or a combination of the two. As will be appreciated by those of ordinary skill in the art, the memory 109 is employed to store a variety of information. For example, the memory 109 may be used to store contact information, such as names, telephone numbers and addresses, voice memos, text messages and image data.

The control unit 110 controls the operation of each component of the wireless telephone 100, as well as the exchange of information between components of the wireless telephone 100. The control unit 110 will typically include a central processing unit, such as a programmable microprocessor or other microcircuit device for processing instructions. The control unit 110 may also include electronic memory, such as memory implemented using microcircuit devices. The memory may be read-only memory (ROM), read/write memory (RAM), or a combination of the two.

The display 111 serves as a display for displaying data provided through the control unit 110. For example, as the user is dialing a telephone number with the key unit 108, the control unit 110 may have the display 111 render the corresponding numbers entered with the key unit 108. Similarly, if the wireless telephone 100 receives an incoming call that identifies its source, then the control unit 110 may have the display 111 show the source information for the call. Still further, the display 111 can be used to provide a user with a menu of actions for the wireless telephone 100. Using the key unit 108, the user can then instruct the wireless telephone 100 to perform one or more of the actions listed on the menu by selecting the desired action on the display 111. As will be appreciated by those of ordinary skill in the art, the display 111 may be any suitable type of display. For example, the display 111 may be a liquid crystal display (LCD), a display formed with light emitting diodes (LEDs), a plasma display, a display that uses organic materials, a cathode ray tube (CRT) display or other type of display.

The DTMF modem unit 112 demodulates dual-tone multi-frequency signals received over the communication network providing service for the wireless telephone. For example, if the wireless telephone 100 is communicating with another telephone through the communication network, the other telephone can convey information to the wireless telephone 100 using dual-tone multi-frequency signals (sometimes referred to as “touchtone” signals) instead of or in addition to voice messages. The DTMF modem unit 112 then inputs data to the control unit 110 based on the demodulated signal. The DTMF modem unit 112 may also be used to modulate data using inputs from the key unit 108.

As will be appreciated by those of ordinary skill in the art, both the sound-emitting unit 113 and the vibrator 1 4 may be used to inform a user of an incoming call. For example, when the telephone 100 receives an incoming call, the control unit 110 may activate the sound-emitting unit 113 to produce a siren, thereby alerting the user to the incoming call. Alternately, or additionally, the control unit 110 may instruct the vibrator 114 to begin vibrating in response to an incoming call.

It will be appreciated that the wireless telephone 100 may communicate through any suitable communications network, such as any suitable public or private network, whether a wide or local area network. In the illustrated embodiment, for example, the wireless telephone 100 is configured to communicate through a mobile communication network, which may be connected to the Internet and which may provide text message communication, such as short message service (SMS).

Service Information and the Retrieval Unit

With various embodiments of the invention, the memory 109 will also contain service information. Some or all of the service information may be stored when the communication apparatus is manufactured. Alternately, some or all of the service information may be added after the communication apparatus is in use or offered for sale. As previously noted, service information may be any information useful to provide service to the communication apparatus. Thus, the service information may include information relating to the characteristics of the communication apparatus, such as identification information that generally identifies the communication apparatus, identification information that uniquely identifies the communication apparatus, or a combination of both.

For example, the service information may include information that generally identifies the type of the communication apparatus, such as a manufacturer's model number for the communication apparatus. The service information may additionally or alternately include a manufacturer's serial number, an electronic serial number for the wireless telephone (which may include the manufacturer's serial number), and/or a mobile identification number (MIN) assigned by the service provider. Of course, the service information may include still other identification information that will generally or uniquely identify the communication apparatus.

The service information may also or alternately include information relating to characteristics of the software that may be employed by the communication apparatus. For example, the service information may specify the software actually resident on the communication application, along with the version of that software. The service information may also or alternately specify what non-resident software can be used by the communication apparatus. For example, the communication apparatus may be compatible with the Java™ programming language, and capable of receiving and rendering hypertext markup language (HTML) files. This information might thus be included with (or as) the service information. In the illustrated embodiment, service information stored in the memory 109 includes the electronic serial number, the model type of the wireless telephone 100, and the version of the software employed by the wireless telephone.

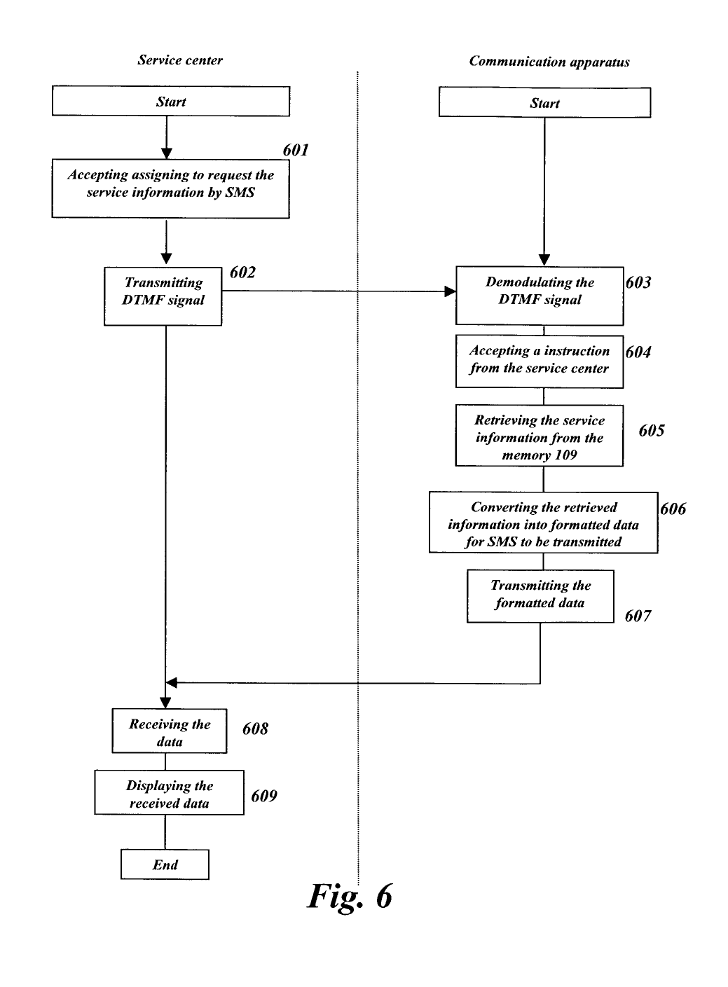

Returning now to FIG. 6, the control unit 110 includes a retrieval unit 1101. As will be discussed in detail below, the retrieval unit 1101 retrieves the service information from the memory 109. It may then provide the retrieved service information to the service provider, or even to a third party. More particularly, the retrieval unit 1101 receives a request for service information. The retrieval unit 1101 may, for example, receive a request for service information from a user. Alternately, the retrieval unit 1101 may receive a request for service information from the service provider that provides communication service for the wireless telephone 100, or even a third party such as another communication device.

More particularly, with some embodiments of the invention, the retrieval unit 1101 can receive a request for service information directly from the user. The retrieval unit 1101 may, for example, provide a menu listing the stored service information through the display 111. Using the key unit 108, the user can then select a specific piece of service information from the menu. In response to the user's selection, the retrieval unit 1101 will then retrieve the selected service information from the memory 109, and display the retrieved service information on the display 111. The user can then simply read the retrieved service information directly from the display 111.

This embodiment of the invention may be particularly useful when the user must obtain service information for the wireless telephone 100. For example, the user may experience a problem with the wireless telephone 100. To address this problem, the user can then employ the wireless telephone 100 to call a service center of the service provider for the wireless telephone 100 directly. If the service center then requires that the user provide them with service information, the user can instruct the retrieval unit 1101 to retrieve convert the required service information to the formatted data to be transmitted by Shorta Message Service (SMS). Once the required service information is retrieved and converted, the user can simply provide the service information to the service center, without having to break off the call with the service center.

With other embodiments of the invention, the service provider may request service information directly. For example, the retrieval unit 1101 may recognize and respond to commands from the service provider that are transmitted to the retrieval unit 1101 through the antenna 101 and the radio unit 102. Thus, the service center can request the required service information directly from the wireless telephone 100. In response to such requests, the retrieval unit 1101 may retrieve the desired service information and convert the retrieved service information into formatted data to be transmitted by SMS. With alternate embodiments of the invention, however, the retrieval unit 1101 may additionally or alternately transmit the retrieved service information back to the service provider through the antenna 101 and the radio unit 102. These embodiments conveniently allow the service provider to retrieve desired service information without having to first define the desired service information to the user. Moreover, receiving the service information directly from the communication devices reduces errors that may occur if the user requests the wrong service information or incorrectly reads back correctly requested service information.

Still other embodiments of the invention may respond to requests for service information from third parties, such as other communication apparatus. For example, the retrieval unit 1101 may be configured to receive commands from other communication apparatus through the antenna 101 and the radio unit 102. Alternately, or additionally, the retrieval unit 1101 may be capable of receiving commands from other communication apparatus through different media, such as a cable or infrared communication port. Thus, another communication device can request specific service information from the retrieval unit 1101. In response, the retrieval unit 1101 will retrieve the requested service information, and provide the retrieved service information to the other communication apparatus. These embodiments may be useful where, for example, the user seeks assistance from a local repairperson, and does not communicate directly with the service provider. The local repairperson can then use this feature of the invention to obtain the necessary service information directly from the communication apparatus.

Retrieval of Service Information by a User

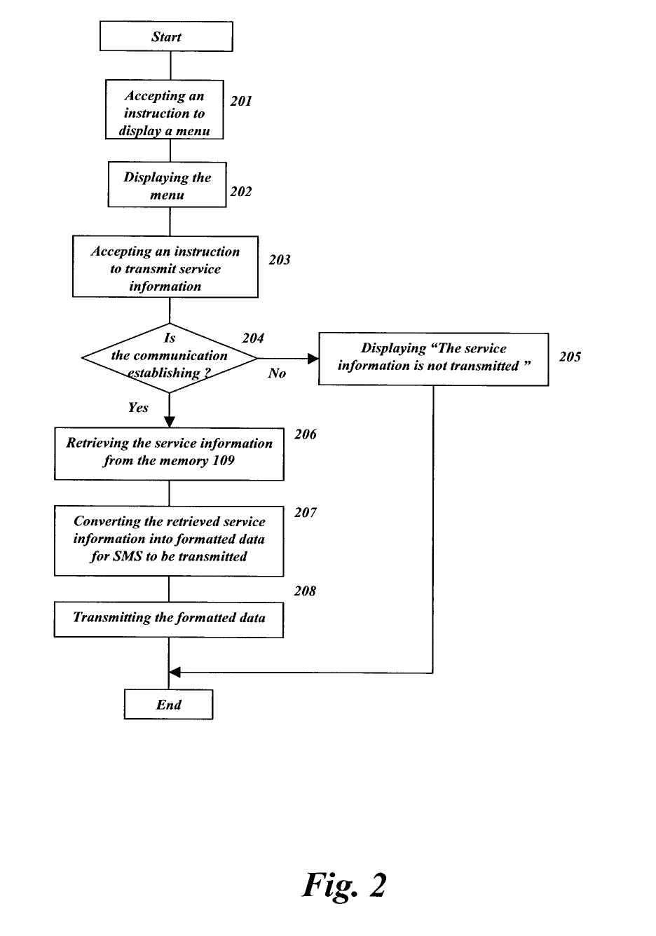

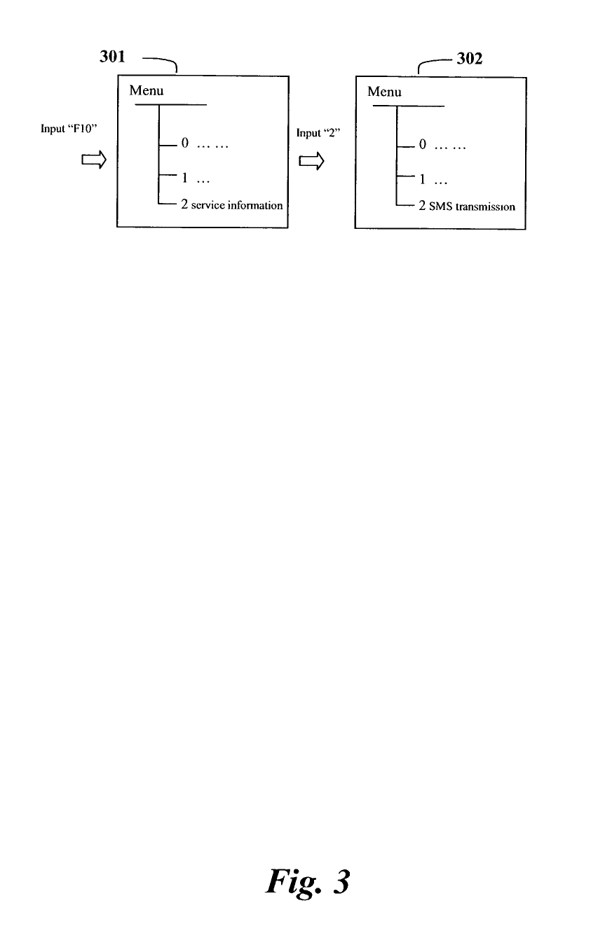

FIG. 2 shows a flowchart depicting an exemplary procedure for retrieving service information requested by a user according to the embodiment of the invention illustrated in FIG. 2. As seen in this figure, in step 201 the retrieval unit first accepts an instruction from the key unit 108 to display a menu listing different information to be transmitted by SMS. In the illustrated embodiment, the instruction to display the menu is given when the user first activates a function key (“F”) and subsequently depresses the key “1” and “0” (10). In response, the retrieval unit 1101 displays a menu of different information to be transmitted by SMS on the in step 202. For example, view 301 in FIG. 3 depicts one example of such a menu that may be displayed on the display 111 in response to a command from a user.

Next, in step 203, the retrieval unit 1101 receives an instruction selecting a transmission of service information to a service center. For example, in the illustrated embodiment, the user may depress the number “2” on the key unit 108 as shown in view 302 of FIG. 3, to transmit service information to a service center by SMS.

Thus, after the user has selected the transmission of service information to a service center, the retrieval unit 1101 displays a menu of choices as to how the requested service information will be provided. As shown in view 302 of FIG. 3, the user may select to have the service information provided by the SMS.

In step 204, the retrieval unit 1101 determines if the wireless telephone 100 is communicating with another party, such as the service provider for the wireless telephone 100. If the wireless telephone 100 is not presently communicating with another party, then in step 205 the message “the service information is not transmitted” may be displayed on the LCD 111 to notify of a user not to be able to transmit the retrieved service information. If, however, the wireless telephone 100 is communicating with another party, then in step 206 it retrieves the service information in the memory 109.

After retrieving the service information, the wireless phone 100 converts the retrieved service information into the formatted data for SMS to be transmitted in the step 207.

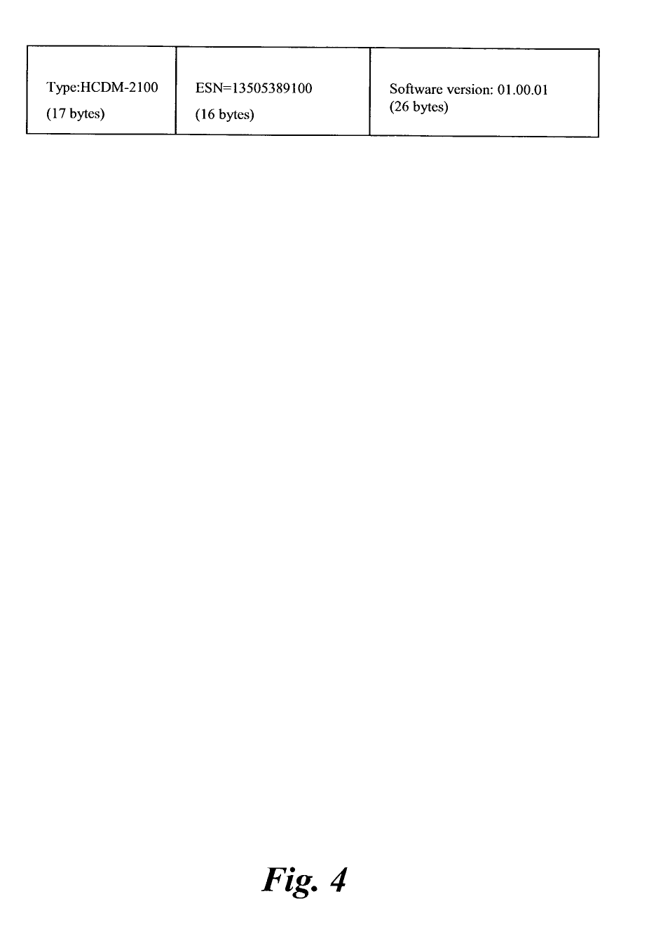

As described in FIG. 4, for example, the retrieval unit 1101 converts the type of the cellular phone into 17 bytes data, ESN into 16 bytes data and the version of software resident on the wireless telephone 100 into 26 bytes data and makes a set of data including these data. For example, the retrieval unit 1101 may convert the service information into the message format based on the communication standard “IS-637” and set the information into Data Burst Message field. The control unit 110 transmits the set service information over a speech channel.

After converting in step 208 the wireless telephone 100 transmits the converted data to that other party. Thus, that other party will be able to receive the service information.

Thus, as described above, the wireless telephone 100 of the illustrated embodiment can conveniently retrieve service information, and can provide the retrieved service information to another party communicating with the wireless telephone 100. It should be noted, however, that the above-described method is exemplary, and not intended to be limiting. Thus, the steps of the method described above can be varied and modified.

Retrieval of Service Information by Another Party

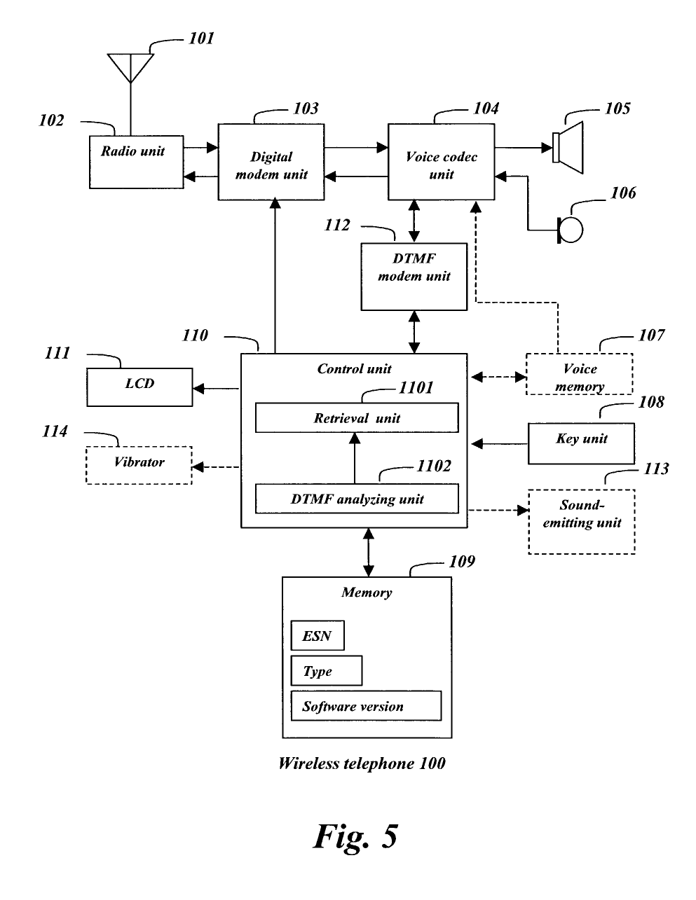

As noted above, various embodiments of the invention will allow another party, such as a service provider or other communication apparatus, to request service information from a communication apparatus implementing the invention. FIG. 5 illustrates one example of a wireless telephone 100 can be used to implement these embodiments of the invention. The wireless telephone 100 is similar to the wireless telephone 100 show in FIG. 1, but additionally includes a Dual-Tone Multi-Frequency (DTMF) analyzing unit 1102, for analyzing and decoding commands provided by a DTMF signal. FIG. 6 then shows a flowchart depicting an exemplary procedure by which another party can request service information from the wireless telephone 100 according to the invention.

More particularly, FIG. 6 depicts a procedure by which a service center of a service provider can request and obtain service information for the wireless telephone 100. After communication is established between the service center and the wireless telephone 100, in step 601 the service center accepts the instruction to require service information from the wireless telephone 100. An operator of the service center may request the instruction. For example, the service center may desire to obtain type information for the wireless telephone 100, the electronic serial number for the wireless telephone 100, and the version of software resident on the wireless telephone 100.

After accepting the instruction, the service center encodes the request into a DTMF signal and transmits the DTMF signal to the wireless telephone 100 in step 602. Upon receiving the DTMF signal, the DTMF analyzing unit 1102 of the wireless telephone 100 analyzes and decodes the signal in step 603. Next, the DTMF analyzing unit 1102 relays the decoded request to the retrieval unit 1101, which accepts the request from the service center in step 604. While the illustrated embodiment employs DTMF signals to relay requests for service information, it should be appreciated, however, that other types of signaling and encoding techniques may alternately be employed.

In step 605, the retrieval unit 1101 retrieves the service information in the memory 109. After retrieving the service information, the wireless phone 100 converts the retrieved service information into the formatted data for SMS to be transmitted in the step 606.

As described in FIG. 4, for example, the retrieval unit 1101 converts the type of the cellular phone into 17 bytes data, ESN into 16 bytes data and the version of software resident on the wireless telephone 100 into 26 bytes data and makes a set of data including these data. For example, the retrieval unit 1101 may convert the service information into the message format based on the communication standard “IS-637” and set the information into Data Burst Message field. The control unit 110 transmits the set service information over a speech channel.

After converting in step 607 the wireless telephone 100 transmits the converted data to the service center. Thus, the service center will be able to receive the service information.

Accordingly, the service center receives the data from the wireless telephone 100 in step 608. Finally, in step 609, the service center displays the received data, for example to notify the data of a technical employee assisting the user of the wireless telephone 100 with a problem. Thus, the technical employee can obtain service information necessary to assist the user without having to explain to the user what service information is required, and without having the user retrieve and relay the required service information.

Conclusion

While the particular embodiments of the invention described above related to wireless telephones, it should be appreciated that the invention is not limited to wireless telephones. For example, the invention may be implemented with cable telephones, Personal Digital Assistants (PDA), or even personal computers that having a communication function.

Service information can be stored in the memory 109 on the way of the manufacturing a wireless telephone 100. A user of a wireless telephone 100 can store service information in the memory 109 by using the key unit 108. The method of storing service information in the memory 109 is not limited to these examples.

Although the invention has been defined using the appended claims, these claims are exemplary in that the invention may include the elements and steps described herein in any combination or sub combination. Accordingly, there are any number of alternative combinations for defining the invention, which incorporate one or more elements from the specification, including the description, claims, and drawings, in various combinations or sub combinations. It will be apparent to those skilled in the relevant technology, in light of the present specification, that alternate combinations of aspects of the invention, either alone or in combination with one or more elements or steps defined herein, may be utilized as modifications or alterations of the invention or as part of the invention. It may be intended that the written description of the invention contained herein cover all such modifications and alterations. For instance, in various embodiments, a certain order to the data has been shown. However, any reordering of the data is encompassed by the present invention.

What is claimed is:

1. A communication apparatus comprising:
a memory configured to store service information for servicing of the communication apparatus;
a retrieval unit configured to retrieve service information from the memory and convert the retrieved service information into data to be transmitted and transmit the converted data to a recipient.

2. The communication apparatus according to claim 1, wherein the service information includes information that identifies the communication apparatus.

3. The communication apparatus according to claim 2, wherein the service information includes information that generally identifies the communication apparatus.

4. The communication apparatus according to claim 3, wherein the service information includes information that identifies a type of the communication apparatus.

5. The communication apparatus according to claim 4, wherein the service information includes a manufacturer's model number for the communication apparatus.

6. The communication apparatus according to claim 2, wherein the service information includes information that uniquely identifies the communication apparatus.

7. The communication apparatus according to claim 6, wherein the service information is an Electrical Serial Number.

8. The communication apparatus according to claim 6, wherein the service information is a manufacturer's serial number for the communication apparatus.

9. The communication apparatus according to claim 1, wherein the service information includes information relating to software that may be employed by the communication apparatus.

10. The communication apparatus according to claim 9, wherein the service information includes information relating to software with which the communication apparatus can communicate.

11. The communication apparatus according to claim 9, wherein the service information includes information relating to software resident in the communication apparatus.

12. The communication apparatus according to claim 11, wherein the service information includes information relating to a version of software resident in the communication apparatus.

13. The communication apparatus according to claim 1, wherein at least a portion of the service information is stored in the memory when the communication apparatus is manufactured.

14. The communication apparatus according to claim 1, wherein at least a portion of the service information is stored in the memory by a user of the communication apparatus.

15. The communication apparatus according to claim 1, wherein the retrieval unit informs a recipient of the retrieved service information in response to a command from another party.

16. The communication apparatus according to claim 15, wherein the another party is a second communication apparatus or a service provider that provides communication service for the first communication apparatus.

17. The communication apparatus according to claim 1, wherein the recipient is another party.

18. The communication apparatus according to claim 17, wherein the retrieval unit transmits the service information to the another party by Short message Service.

19. A service center, comprising;
a transmitter configured to transmit a command to retrieve service information for servicing of a communication apparatus to the communication apparatus; and
a receiver configured to receive service information from the communication apparatus.

20. The service center according to claim 19, wherein the transmitter transmits the command as a Dual Tone Multi-Frequency signal.

21. The service center according to claim 19, wherein the receiver receives the service information by Short Message Service.
